(19) United States
(12) Patent Application Publication
(10) Pub. No.: US 2018/0042204 A1
(43) Pub. Date: Feb. 15, 2018

(54) Hands-free Pet Leash Device

(71) Applicant: Jessie Davis, North Charleston, SC (US)

(72) Inventor: Jessie Davis, North Charleston, SC (US)

(21) Appl. No.: 15/235,501

(22) Filed: Aug. 12, 2016

(51) Int. Cl. A01K 27/00

(52) U.S. Cl. CPC A01K 27/003; A01K 27/005

(57) ABSTRACT

A hands-free pet leash device comprising a wearable belt including a glider movably attached to the belt, wherein the glider is configured to rotate circumferentially around the wearable belt. The glider is configured to move around the wearable belt via a guide element wherein the glider can move along the guide element and rotate around the guide element. The wearable belt is made up of synthetic polymers along with an interlocking mechanism at the terminals of the wearable belt. The guide element can be a guide wire fixed along the length of the wearable belt through a connector over which the glider is free to perform circular motion along the path with the motion of the corresponding leash as the pet moves around. A push button is provided on the belt for hook up and release purposes. The glider is capable of rotating up to 355 degrees along either direction around the belt.

### FIELD

Example embodiments of the inventive concepts relate to a leash handling belt for restraining pets during running or walking.

### BACKGROUND

People walking or jogging with their pets are often obstructed with a handheld leash. When jogging, such a leash can be very inconvenient and can lead to many problems. For example, the handheld leash can put extra pressure on pet's collar that may lead to injury. The leash has to be shifted from one hand to another as the pets move around the pet owner. Therefore, a need exists for a new and improved hands-free rotatable leash mechanism for pets.

### SUMMARY

One aspect of the inventive concept can be embodied in a hands-free pet leash device comprising a wearable belt including two terminals, a glider movably attached to the belt, and a leash, wherein the glider is configured to move circumferentially around the wearable belt; and the leash is configured to be coupled to the glider.

Other aspect of the inventive concept can be embodied in a hands-free pet leash device comprising a wearable belt including two terminals; a glider movably attached to a circumferential guide element attached with the belt, and a leash, wherein the glider is configured to move circumferentially around the wearable belt via the guide element and rotate around the guide element; and the leash is configured to be coupled to the glider.

In an example embodiment, the leash is capable of rotating with the help of glider mechanism around the wearable belt and is attached to the wearable belt.

In another example embodiment, the leash is capable of rotating with the help of the glider mechanism around the belt circumferentially engaged with an interlocking tip terminal.

In another example embodiment, the belt assembly is fabricated from wire, tube or pipe assembly for allowing the gliding mechanism. The hands-free leash provides both the wearer and the pet a hassle free run or walk without the need of restraining pets while holding lease in hands and switching the leash between hands.

In another example embodiment, the belt is coupled to the leash with the help of a glider arrangement that is free to rotate and move on the wire, tube or pipe assembly. With the involvement of free gliding leash, pet can run at different angles with the wearer. The belt structure is made up of relatively stronger and tougher material such as nylon.

In another example embodiment, the belt with metal interlocking at its ends makes the hook up and release mechanism robust. The belt can be wearable at various body parts including waist or wrist of the wearer.

In another example embodiment, the guide wire can be in the form of a tube, pipe or metal wire coupled within the wearable belt structure.

In another example embodiment, the wearable belt can be available in different shapes and sizes for wearers belonging to all ages.

In another example embodiment, the belt is configured to be wearable to supporting body parts particularly at waist or wrist of the wearer.

In another example embodiment, the glider is capable of rotating at the maximum of 355 degrees from one end to the other.

### BRIEF DESCRIPTION OF THE DRAWINGS

The example embodiments of the inventive concept will be better understood from the following brief description taken in conjunction with the accompanying drawings. The drawing FIGS. 1-5 represent non-limiting, example embodiments.

FIG. 1(a) and FIG. 1(b) show a hands-free pet leash device and sliding mechanism according to an example embodiment.

FIG. 2 shows a hands-free pet leash device including a wire or pipe element as sliding element.

FIG. 3-7 show different views of a hands-free pet leash device according to another example embodiment.

### DETAILED DESCRIPTION

In the following description, reference is made to the accompanying drawings which form a part hereof, and in which is shown by way of illustration specific embodiments in which the inventive concept may be practiced. These embodiments are described in sufficient detail to enable those skilled in the art to practice the inventive concept, and it is to be understood that the embodiments may be combined, or that other embodiments may be utilized and that structural and logical changes may be made without departing from the spirit and scope of the present inventive concept. The following description is, therefore, not to be taken in a limiting sense.

Example embodiments of the inventive concepts may be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, some dimensions are exaggerated for clarity.

It will be understood that when an element is referred to as being “connected” or “coupled” to another element, it can be directly connected or coupled to the other element or intervening elements may be present.

The terminology used herein is for the purpose of describing particular embodiments only and is not intended to be limiting of example embodiments of the inventive concepts. As used herein, the singular forms “a” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

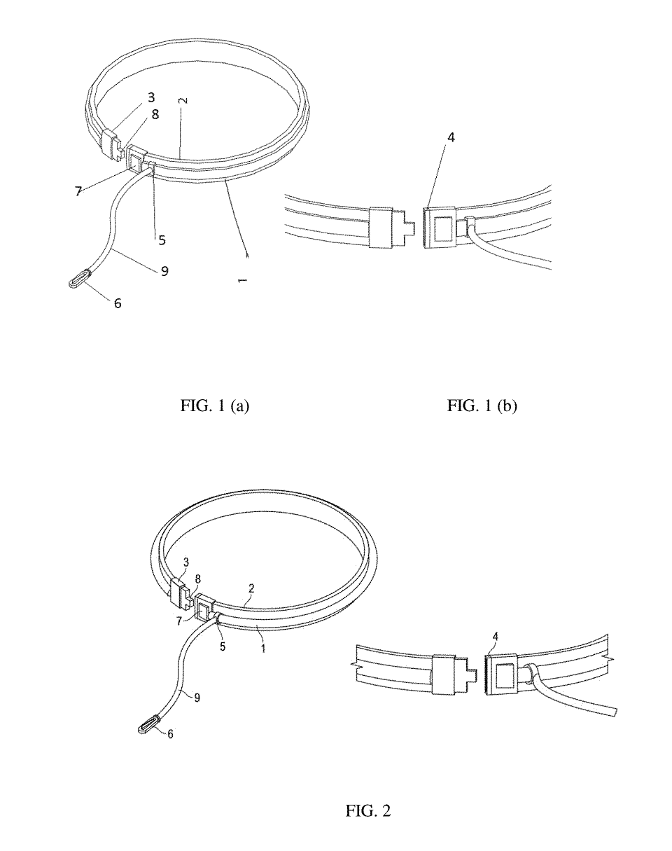

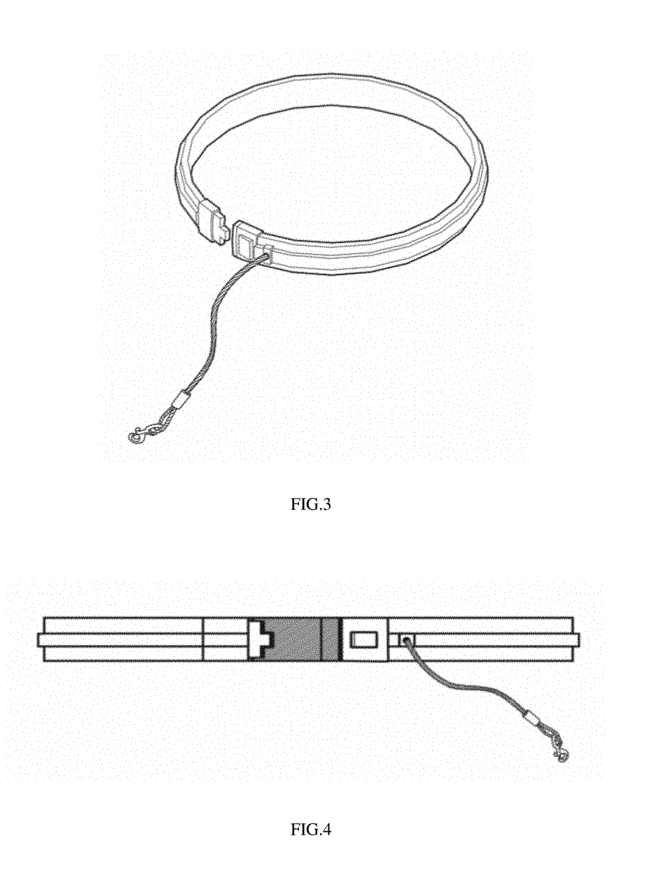

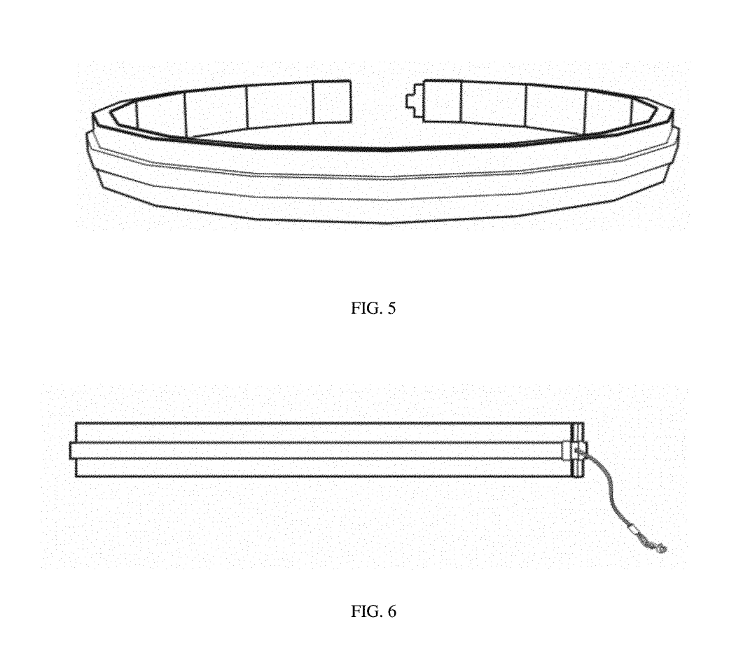

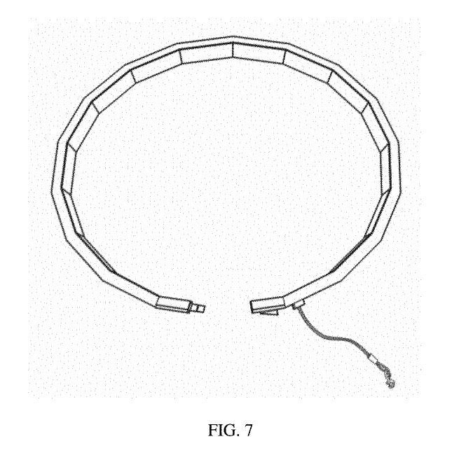

FIGS. 1-2 show hands-free pet leash device. A guided wire or guide element 1 is connected to the guide wire connector 3 towards one end of the belt engaged by an interlocking metal tip 8. The guide wire 1 is made up of a material that is capable of bearing loads without breaking when the glider 5 is engaged in rotation around the guide wire or glide to rotate around the belt. The guide wire 1 is enclosed within an outer covering of the belt structure 2. The guide wire 1 can be in the form of a tube or metal wire coupled to the wearable belt structure 2. The wearable belt structure 2 is comprised of synthetic material.

In an example embodiment, the wearable belt structure is fabricated from nylon.

The glider 5 is attached at the head terminal of the leash 9. The leash 9 may be of any suitable length appropriate enough to accomplish the requirement. The tail of leash 9 is provided with a snap hook 6 mechanism used to couple the leash 9 with the strap restrained in the collar of pets. An interlocking tip 8 is provided at one end of the wearable belt that is capable of locking the belt to the other end. A push button 7 and quick release mechanism 4 are provided on the wearable belt for the hook up and release mechanisms.

FIG. 2 is a schematic representation of leash sliding mechanism over the guide wire 1. The leash is engaged to the belt using a glider 5 mechanism that is capable of rotating circumferentially around the belt in any direction via the guide wire or element 1.

The glider 5 and snap hook 6 are attached at the two different terminals of the leash the head terminal and the tail terminals respectively. The rotating mechanism can be of any means. The glider 5 can also be designed to slide over the guide wire 1 providing a smooth motion around the wearable belt without applying any jerk on the body of the wearer.

In another example embodiment, the guide wire 1 is fused in the belt cover and can be made up of a tube or pipe assembly that provides a sliding or rotational motion to the glider 5. The interlocking tip 8 as shown in the FIGS. 1-2 is used for hook up locking mechanism at the time of engagement of the belt. The interlocking tip 8 can be made up of hard material capable enough to engage the belt assembly in locked position.

In an example embodiment, the interlocking tip 8 is made up of steel.

In a further example embodiment, the glider is configured to glide along the tube or wire 1, and rotate around the tube or wire 1 so that leash 9 can move around belt structure 2 or move up or down around the belt structure 2 so that the belt can be used at various parts of the body.

The slider 5 moves from one end of the belt to the other end but it cannot bypass the belt interlock terminal region of connector 3 or interlock tip 8, thus restricting the motion up to about 355 degrees. The glider 5 cannot make continuous circular movements around the guide wire 1 of the belt assembly, thus can make a circular movement in either direction.

In a further example embodiment, the slider motion can be restricted to various ranges by using restricting mechanism in the guide element. For example, the motion can be restricted up to 180. In another example embodiment, the motion can be restricted up to 180 degrees up to 355 degrees.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present inventive concept have been described above with regard to specific embodiments. These benefits and advantages, and any elements or limitations that may cause them to occur or to become more pronounced are not to be construed as critical, required, or essential features of any or all of the embodiments.

While this specification contains many specific implementation details, these should not be construed as limitations on the scope of any inventive concept of what may be claimed, but rather as descriptions of features that may be specific to particular embodiments of particular inventive concept. Certain features that are described in this specification in the context of separate embodiments can also be implemented in combination in a single embodiment. Conversely, various features that are described in the context of a single embodiment can also be implemented in multiple embodiments separately or in any suitable sub combination.

What is claimed is:

1. A hands-free pet leash device comprising:
a wearable belt including two terminals, a glider movably attached to the belt, and a leash, wherein
the glider is configured to move circumferentially around the wearable belt; and
the leash is configured to be coupled to the glider.

2. The hands-free pet leash device of claim 1, wherein the leash has a head terminal and a tail terminal.

3. The hands-free pet leash device of claim 1, wherein a guide wire is fixed along the length of the wearable belt through a connector and the glider is configured to move over the guide wire.

4. The hands-free pet leash device of claim 1, wherein a push button is provided on the wearable belt for hook up and release of the terminals.

5. The hands-free pet leash device of claim 1, wherein the glider is further configured to rotate up to 355° along either direction.

6. The hands-free pet leash device of claim 1, wherein the wearable belt is configured to be wearable at a supporting body including at least one of wait and wrist.

7. The hands-free pet leash device of claim 2, wherein the leash is configured to be coupled to the glider at the head terminal.

8. The hands-free pet leash device of claim 2, wherein the leash is configured to be coupled to a snap hook at the tail terminal.

9. The hands-free pet leash device of claim 8, wherein the wearable belt is made up of synthetic polymers.

10. The hands-free pet leash device of claim 9, wherein the synthetic polymer is nylon.

11. A hands-free pet leash device comprising:
a wearable belt including two terminals;
a glider movably attached to a circumferential guide element attached with the belt, and
a leash, wherein
the glider is configured to move circumferentially around the wearable belt via
the guide element and rotate around the guide element; and
the leash is configured to be coupled to the glider.

12. The hands-free pet leash device of claim 11, wherein the leash has a head terminal and a tail terminal.

13. The hands-free pet leash device of claim 12, wherein the two terminals of the wearable belt are configured to be coupled to each other via an interlocking mechanism located at one of the wearable belt terminals.

14. The hands-free pet leash device of claim 12, wherein the guide element is a guide wire or pipe fixed along the wearable belt through a connector over which the glider is free to move.

15. The hands-free pet leash device of claim 12, wherein the leash is configured to be coupled to the glider at the head terminal.

16. The hands-free pet leash device of claim 12, wherein the leash is configured to be coupled to a snap hook at the tail terminal.

17. The hands-free pet leash device of claim 14, wherein the wearable belt is made of recyclable plastic.

18. The hands-free pet leash device of claim 14, wherein the wearable belt and leash is made up of synthetic polymers.

19. The hands-free pet leash device of claim 14, wherein the synthetic polymer is at least one of polystyrene, nylon, and kevlar.

20. The hands-free pet leash device of claim 14, wherein the rotation of the glider is up to 355 degrees.
